(19) United States
(12) Patent Application Publication
(10) Pub. No.: US 2023/0245644 A1
(43) Pub. Date: Aug. 3, 2023

(54) END-TO-END MODULAR SPEECH SYNTHESIS SYSTEMS AND METHODS

(71) Applicant: SPEECH MORPHING SYSTEMS, INC., San Jose, CA (US)

(72) Inventors: Fathy F. YASSA, San Jose, CA (US); Mark Seligman, Berkeley, CA (US); Darko Pekar, Novi Sad (RS)

(73) Assignee: SPEECH MORPHING SYSTEMS, INC., San Jose, CA (US)

(21) Appl. No.: 18/161,474

(22) Filed: Jan. 30, 2023

Related U.S. Application Data
(60) Provisional application No. 63/304,088, filed on Jan. 28, 2022.

(51) Int. Cl. G10L 13/10; G10L 21/10

(52) U.S. Cl. CPC G10L 13/10; G10L 21/10

(57) ABSTRACT

A method for speech synthesis using prosody capture and transfer includes receiving a first speech in a target prosody and receiving a second speech in a target voice; extracting prosodic features from a first speech segment in the target prosody; generating a synthetic speech segment in the target voice with the target prosody based on transferring the prosodic features from the first speech segment per phoneme to a second speech segment.

### CROSS-REFERENCE TO RELATED APPLICATION

The present application claims the benefit of priority to U.S. Provisional Application 63/304,088, filed on Jan. 28, 2022, in the United States Patent and Trademark Office, the entire contents of which are hereby incorporated by reference in their entirety.

### FIELD

Various embodiments of the present disclosure relate generally to speech processing. More particularly, various embodiments of the present disclosure relate to speech systems for synthesizing speech based on prosody capture and transfer, and/or based on vocal demonstration of correct pronunciation. Also disclosed are novel means of representing prosodic elements of speech segments.

### BACKGROUND

Speech synthesis (text-to-speech (TTS) or speech conversion) has become increasingly widespread and vital for human-computer and human-human interaction. TTS technology quickly reached a threshold level of realism and has remained at that level for decades without significant improvements.

Now, explosive development of automatic speech recognition, natural language processing, translation, and artificial intelligence has raised the demand for synthetic speech (in many languages) that can approach human quality and expressiveness. However, speech synthesis technology in the related art is still handicapped by issues associated with quality of pronunciation and prosody in various languages and accents. Tuning and correction tools used to solve the above-mentioned issues, e.g., to enable offline post-tuning of preliminary speech synthesis results, have remained insufficient.

### SUMMARY

According to an aspect of one or more embodiments, a method is provided for synthesizing speech using prosody capture and transfer in which the method may include receiving a first speech segment in a target prosody; receiving a second speech segment in a target voice; extracting prosodic features from a first speech segment in the target prosody; and generating a synthetic speech segment in the target voice with the target prosody based on transferring the prosodic features from the first speech segment per phoneme to a second speech segment.

According to additional aspects of one or more embodiments, computer systems and non-transitory computer readable medium that are consistent with the method are also provided.

### BRIEF DESCRIPTION OF THE DRAWINGS

The patent or application file contains at least one drawing executed in color. Copies of this patent or patent application publication with color drawings will be provided by the Office upon request and payment of the necessary fee. Various embodiments of the present disclosure are described below with reference to the accompanying drawings, in which:

FIG. 1A-D are diagrams illustrating exemplary displays for generating synthetic speech based on prosody capture and transfer, in accordance with embodiments of the present disclosure;

FIG. 2 is a diagram illustrating correction pronunciation of generated synthetic speech based on prosody capture and transfer, in accordance with embodiments of the present disclosure;

FIG. 3A-B is a diagram illustrating re-synthesizing generated synthetic speech in a style or tone, in accordance with embodiments of the present disclosure;

FIG. 4 is a flowchart that illustrates a method for generating synthetic speech based on prosody capture and transfer, in accordance with embodiments of the present disclosure;

FIG. 5A-B are block diagrams illustrating exemplary API call flows in a system generating synthetic speech based on prosody capture and transfer; and

FIG. 6 is a block diagram of a device for generating synthetic speech, in accordance with embodiments of the present disclosure.

### DETAILED DESCRIPTION

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

The accompanying drawings illustrate the various embodiments of systems, methods, apparatuses and non-transitory computer readable mediums, and other aspects of the disclosure. Throughout the drawings, like reference numbers refer to like elements and structures. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

The features discussed below may be used separately or combined in any order. Further, various embodiments may be implemented by processing circuitry (e.g., one or more processors or one or more integrated circuits) or processing entities (e.g., one or more application providers, one or more application servers, or one or more application functions). In one example, the processor or processors may execute a program that is stored in a non-transitory computer-readable medium.

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

As an example of the deficiencies in related art, tuning tools require a means of tracking and gauging the elements of prosody—pitch, speech, rhythm, and volume. Various graphic displays have been developed, but all suffer from one or more defects: (1) pitch is not consistently indicated by vertical position (iconicity has been lacking); (2) the vertical scale indicating pitch has been marked in units that are not easily perceived or understood by users; and (3) pitch is indicated in terms of specific (fixed, absolute) pitches, e.g., as rising from one specific hertz value to another.

As another example, preliminary synthesis of speech often lacks the desired prosody or has incorrect pronunciation for words or phrases.

The present disclosure describes unprecedented methods and systems for tuning and correcting text-to-speech that can alleviate the above-mentioned deficiencies and meet these tuning and correction needs. The present disclosure presents an innovative combination of techniques, some of which have previously been applied to speech conversion, that focus on prosodic and pronunciation features for text-to-speech applications. Prosodic features of a speech segment pronounced by a given voice, e.g., its pitch, duration, volume, etc., may be captured per voice sub-segment or phoneme and exploited during TTS and re-synthesis in another voice, such that those prosodic features may be heard in the resulting synthetic speech. This process may be referred to as “PCAT” or “prosody capture and transfer.” Additionally, pronunciation errors in a given synthetic segment can be corrected via spoken demonstration, as well as via text-based indications.

According to embodiments, the pronunciation and prosody of a synthetic voice segment can be made to approach the desired pronunciation and prosody arbitrarily closely. Not only do the embodiments enable unique capture of vocally demonstrated pronunciation and prosody as explained; they also support manual tuning in unprecedented ways. This novel and inventive capture capability, whether exploited through demonstration or through manual tuning, not only enables previously unattainable vocal realism in artificial speech; crucially, it also enables tuning at scale—that is, for fine-tuned text-to-speech in industrial quantities.

Contrary to uses of untuned (out-of-the-box or fully predicted) speech synthesis, in which all aspects of the result are produced via learned predictions, embodiments of the present disclosure use prosodic features per speech sub-segment, e.g., per phoneme, captured and transferred from a recording with a target voice. This use of the prosodic features of a demonstration voice enables unprecedented fine tuning of the synthetic speech output, thus also enabling subtle expression of emotions, cognitive states, attitudes, and other aspects of personality and realism to a degree not previously possible.

According to an embodiment, initial synthetic speech may be generated. The input may be a recording and a matching text segment, both providing target content to be synthesized, or the input may be only speech. In embodiments where the text is not included in the input, it may be recovered using automatic speech recognition (ASR or speech-to-text) of the recording. The recording may have been produced in advance, or may be supplied by microphone just prior to synthesis. The resulting synthetic segment may be used immediately; it may be saved for future use; or it may be subject to further revision.

As stated above, graphic displays used during tuning suffer from a number of defects. Various embodiments of the present disclosure resolve these defects. Embodiments of the present disclosure preserve iconicity, in that vertical difference always indicates pitch difference. Reference lines on the graphical representation (also referred to as the “staff” throughout this disclosure) are specially marked to help identify important pitch intervals. According to embodiments of the present disclosure, musical half-tones (semi-tones) are employed as the unit of pitch interval in a way familiar to users conversant with music. Using musical half-notes in the representation is beneficial for annotating actual music and for enabling artificial singing. In addition, pitch notation is represented relative to the current speaker's neutral tone, and may be moved to represent different speakers' neutral tones or levels of excitement. Embodiments of the disclosure also feature innovative indications of rhythm and volume.

To generate synthetic speech free of mispronunciations or lacking correct prosody, embodiments of the present disclosure enable a user to vocally demonstrate the desired pronunciation or correct prosody in the manner already explained. Aspects or segments of the demonstration may be captured and transferred to a preliminary synthetic speech segment, enabling modification of appropriate segments of that preliminary speech to mimic the correct elements as demonstrated. This corrected preliminary speech, once approved, may serve as feedback to the user. This process may be repeated until a completely satisfactory revision is achieved. In this way, embodiments of the disclosure can capture relevant changes of pitch, speed, rhythm, and volume and either transfer them automatically or enable manual modifications of them. Pronunciation corrections can be handled in a comparable way. Different embodiments may use different methods for prosody capture.

A method used may include direct prosody capture, whereby information on pitch movement, segment duration (rhythm), and changes of volume (loudness) may be directly captured from the demonstrated speech signal, without the benefit of any further analysis or coding of these elements. As explained, this information may then be transferred to the preliminary synthetic vocal segment to enable re-rendering (also referred to as “re-synthesizing”) of the correct speech. Embodiments can enable maximally accurate capture and transfer of these elements, limited only by the resolution (e.g. frame rate) of the signal itself. The results are especially useful for dubbing, since the synthetic rhythm will exactly follow that of the demo performance. Since the pitch and loudness will likewise follow the demonstration exactly, the artificial voice will sound natural, rather than “robotic.”

A method used may include coded prosody capture. Information on the prosody of the demonstration may automatically be converted into codes which represent its pitch, duration, and volume. Those codes may then be transferred to the preliminary synthetic segment so that it can be re-rendered. By increasing the number and precision of codes for each feature, this technique can be adjusted to permit reproduction of the demo's prosody at increasingly fine degrees of resolution and accuracy. While direct capture is highly accurate, coded prosody capture is useful for several purposes. As examples, since the codes may be understood by users, the codes may be used in interactive interfaces for prosody adjustment. The codes may also contribute to machine learning of the relationships between text and prosody to facilitate prosody prediction, as opposed to prosody post-editing.

Embodiments of the present disclosure relate to a display or interface that enables user manipulation of selected TTS segments or preliminary speech segments. Using any standard mouse or digital pen, users may change the height and length of a prosody curve, effectively affecting its pitch contour and duration. Users may also easily modify a segment's length, the relative duration of its sub-segments (their rhythm), and its volume. An inventive way of manipulating selected TTS segments or preliminary speech segments is to drag or click a curve or a text representing a speech segment (which may be as short as a phoneme) to make it higher or lower (that is, to change its pitch), make it longer or shorter (to change duration of the segment), or bolder (to change its volume or loudness).

In some embodiments, when the preliminary speech includes segments, words, or phrases that are mispronounced, users may vocally or textually demonstrate the desired pronunciation. In some embodiments, the mispronounced preliminary speech segments may be highlighted, by a user or automatically. Then, the user may demonstrate or textually enter the preferred pronunciation of the segment. Embodiments may capture that pronunciation and represent it in the International Phonetic Alphabet (IPA). In embodiments, the synthetic voice rendering the synthetic speech may pronounce it for verification, and, if the correct pronunciation is approved, it may be substituted in the segment, and the corrected utterance as a whole may be re-rendered.

Embodiments of the present disclosure relate to selecting and changing a tone, mood, or style of a segment in the preliminary speech or synthetic speech. In some embodiments the user may select a segment and then change the segment's tone or mood (emotional quality, e.g., emphatic, stern, neutral, happy, angry, friendly, or sympathetic) or style (e.g., announcer or promotional), using dedicated voice models with built-in tones and styles or via machine learning techniques which can supply and substitute the vocal features of learned tones and styles.

During training of synthetic voice models or during tuning of preliminary synthetic segments, it may be beneficial to coach the user to perform a particular prosody for a certain segment. Embodiments of the present disclosure provide a graphic representation of the target prosody, along with audible synthetic or recorded models. The user's attempts to imitate that prosody are likewise represented graphically on the same display so that the two renderings can be easily compared. Additionally, a closeness score may calculated and presented, for example as a percentage, where 100% may indicate a perfect prosodic imitation. As additional feedback, the score may also be translated into levels, such as excellent, satisfactory, and unsatisfactory, and these may also be represented in some graphic form, e.g., as green, yellow, or red traffic lights. Playback of the two prosodies may also be enabled, either separately or simultaneously. Once an acceptable score is achieved, the user's rendering may be saved for training or tuning purposes.

According to an embodiment, synthetic speech segments may be substituted for recorded segments. The substitute segments may be prepared using the prosody capture and transfer methods of the current disclosure, or they may be untuned.

Voice Segment Restoration exemplifies such substitution. The speech recording to be restored may be a legacy voice segment which has been damaged or lost. If the legacy segment is part of a voice track in a video where lip movements are visible, newly synthesized segments may automatically provide lip synch, and they may exactly preserve the speech rhythm of the unsatisfactory original segments. Voice Segment Restoration may thus create a synthetic replacement for the original voice recording segments based on other recordings provided for this purpose, whether prepared previously or on the spot via a microphone.

According to an embodiment, synthetic speech may be generated for multiple text segments or multiple speech segments in a single process. Input may be a list of current but unsatisfactory synthesis segments or sub-segments, a matching list of speech recordings, and optionally, a matching list of texts to be synthesized. This “batch” prosody capture and transfer technique may be used to synthesize, in batch mode rather than individually, all of the segments (phrases, sentences, paragraphs, etc.) in an audiobook, movie script, etc.

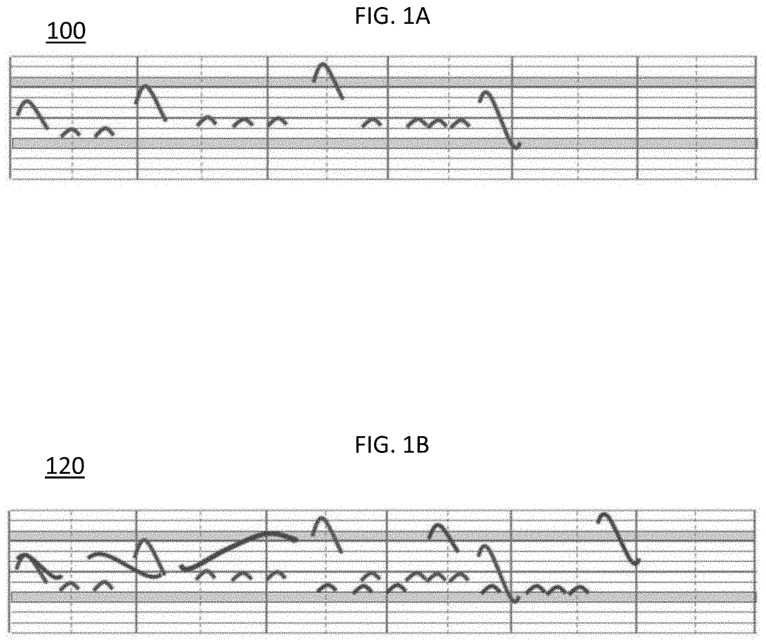

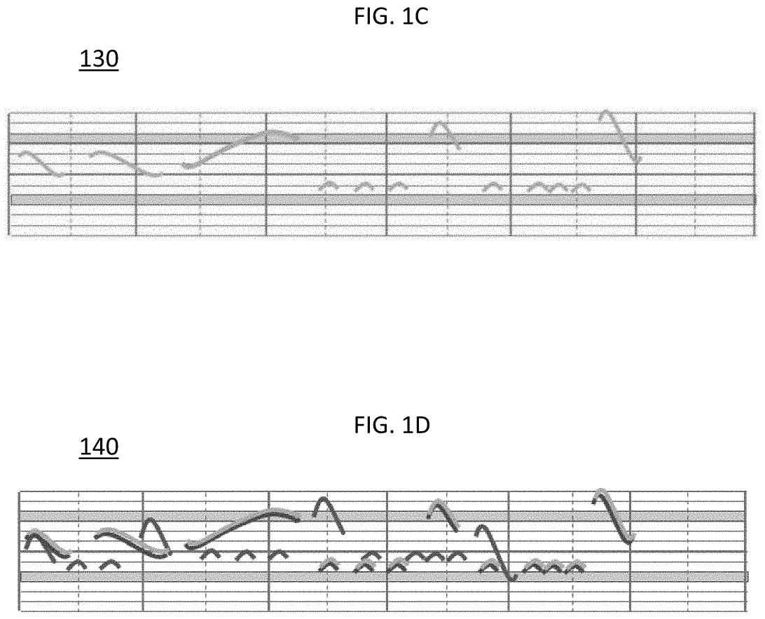

FIG. 1A-D are graphical representations 100-140 illustrating exemplary displays for generating synthetic speech based on prosody capture and transfer. FIG. 1A shows in blue the right voice (right color) but undesirable prosody, FIG. 1B shows an overlay in red of a different voice with the desired prosody, and FIG. 1C shows in purple a combined output in which the desired prosody has been captured from the first voice and transferred to the second voice.

In FIG. 1A-D, the reference lines under graphical representations 100-140 (the “staff”) are specially designed to identify pitch intervals and rhythm. The distance between each horizontal reference line and its neighboring space indicates a musical-half tone (semi-tone) that is employed as a unit of pitch interval. The staff represents one octave above the center line as twelve musical half-steps, and similarly one octave below it. The grey spaces represent musical perfect fifths, and are included as significant reference points familiar to musicians. Changes in the pitch are always represented as vertical changes. Thus, pitch representation, and representation of changes in the pitch are iconic and consistent. Additionally, the center reference line may indicate a relative pitch center or a changeable neutral tone that is specific to a particular user. Thus, similar changes in pitch, regardless of a user's specific voice, may be reflected in the same way across multiple users. Each vertical reference line, also referred to as a “bar,” may indicate a time interval, e.g., one second, half-second, etc., as needed. This quasi-musical staff for pitch representation is especially intuitive for users familiar with music and enables artificial singing, but also exploits intervals perceptible by most listeners. In addition, representation of pitch notation relative to the current speaker's neutral tone enables representation of vocal or musical intervals independent of a given speaker's neutral tone or level of excitement. In embodiments, the text to be converted to speech may be written below the staff and may be bolded, italicized, or underlined to indicate volume. In some embodiments, a thickness of the curve on the staff may also be used to indicate the volume of a speech segment or phoneme.

In FIG. 1A, graphical representation 100 represents a preliminary synthetic speech in the desired target voice with the desired content but with an unsatisfactory prosody. In embodiments, graphical representation 100 may be referred to as second speech. In FIG. 1B, graphical representation 120 represents a speech that has the desired content (text or speech) and the desired prosody. In embodiments, graphical representation 120 may be referred to as first speech. In FIG. 1C, graphical representation 130 represents a synthetic speech segment generated in the target voice and with the desired prosody achieve by transferring extracted prosodic features from graphical representation 120. The generation of synthetic speech segment 130 is based on a per transfer per speech sub-segment (minimally per phoneme) of the extracted prosodic features. In FIG. 1D, graphical representation 140 represents a simultaneous placement of graphical representations 100-130 on the staff.

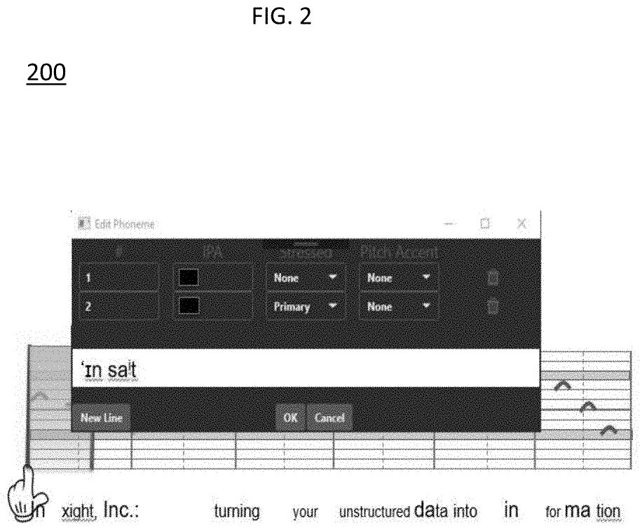

FIG. 2 is a diagram 200 illustrating selection and correction of pronunciation in the synthetic speech segment, as obtained through extraction of phonetic information from a vocal demonstration. In some embodiments, diagram 200 may illustrate an interactive correction of pronunciation of generated synthetic speech based on pronunciation capture and transfer, comparable to prosody capture and transfer.

As shown in FIG. 2, a user may, either automatically or manually, manipulate the synthetic speech segments if they are mispronounced by changing a height and length of a prosody curve, thus affecting its pitch contour and duration. Users may also easily modify a speech segment's length, the relative duration of its segments (their rhythm), and volume.

In some embodiments, selected segments may be manipulated by dragging or clicking a curve or a text representing a speech sub-segment to make it higher or lower (changing pitch), make it longer or shorter (changing duration of the segment), or thicker (louder, changing volume).

In some embodiments, the speech segment that is mispronounced may be corrected as follows. The mispronounced speech segment may be highlighted and a dialogue box enabling the user to demonstrate the preferred pronunciation of the segment may be presented. The user's pronunciation may be captured automatically and represented in the International Phonetic Alphabet (IPA) or in an alternative notation. The target voice may also pronounce the word for verification. If the user is satisfied, the word as correctly pronounced will be substituted, and the corrected utterance as a whole will be synthetically pronounced. The corrected pronunciation may also be saved for future use per use case or user.

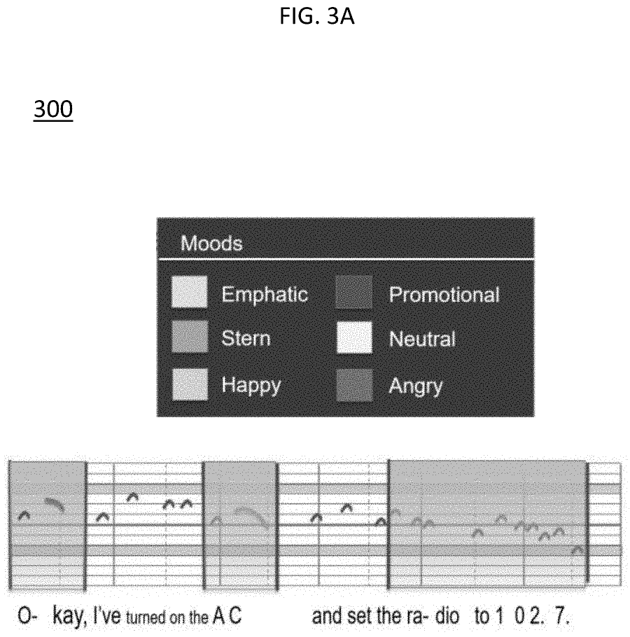

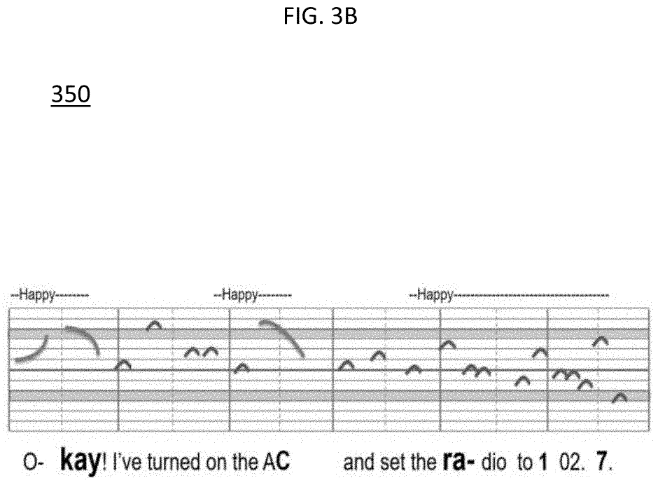

FIG. 3A-B include diagrams 300 and 350 respectively that illustrate a process of re-synthesizing the generated synthetic speech in a specific style or tone, e.g., happy tone.

In FIG. 3A, diagram 300 indicates segments of a preliminary speech segment being selected for style and tone morphing, along with the options of style and tone available in a system. Diagram 350 of FIG. 3B represents the style and tone modifications of selected segments of the preliminary speech, as shown via the graphical representation. In some embodiments, style or tone used may have been previously modeled using prosody capture and transfer.

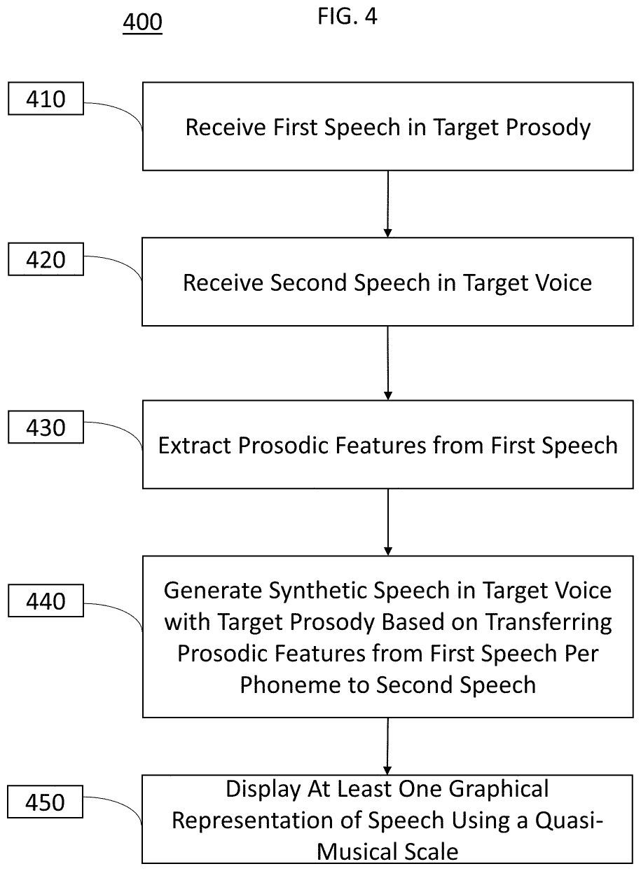

As shown in FIG. 4, process 400 may be used for generating synthetic speech based on prosody capture and transfer.

At operation 410, a first speech segment in a target prosody may be received. As an example, a segment such as that represented in graphical representation 120 may be received by a processor.

At operation 420, a second speech segment in a target voice may be received. As an example, a segment such as that represented by graphical representation 100 may be received by a processor.

At operation 430, prosodic features from the first speech segment in the target prosody may be extracted. According to an embodiment, a method used may include direct prosody capture. Information on pitch movement, segment duration (rhythm), and changes of volume (loudness) may be directly captured from the demonstrated speech signal, without the benefit of any analysis or coding of these elements. This information may then be transferred to the preliminary synthetic vocal segment to enable re-rendering (also referred to as “re-synthesizing”) of the correct speech. Embodiments enable maximally accurate capture and transfer of these elements, limited only by the resolution (e.g. frame rate) of the signal itself. The results are especially useful for dubbing, since the synthetic rhythm will exactly follow that of the demo performance. Since the pitch and loudness will likewise follow the demonstration exactly, the artificial voice will sound natural, and not very “robotic.”

According to an embodiment, a method used may include coded prosody capture. Information on the prosody of the demonstration may automatically be converted into codes which represent its pitch, duration, and volume. Those codes may then be transferred to the preliminary synthetic segment so that it can be re-rendered. By increasing the number and precision of codes for each feature, this technique can be adjusted to permit reproduction of the demo's prosody at increasingly fine degrees of resolution and accuracy. While direct capture is highly accurate, coded prosody capture is useful for several purposes. As examples, since the codes may be understood by users, the codes may be used in interactive interfaces for prosody adjustment. The codes may also contribute to machine learning of the relationships between text and prosody to facilitate prosody prediction, as opposed to prosody post-editing.

At operation 440, synthetic speech in the target voice with the target prosody may be generated based on a transfer of the prosodic features from the first speech per phoneme to the second speech. As an example, prosodic features from graphical representation 120 may be extracted and transferred, per phoneme, to the graphical representation 100 to generate synthetic speech represented by graphical representation 130.

As stated above, this use of voice specific prosodic features, enables unprecedented fine tuning of the synthetic speech output, thus enabling subtle expression of emotions, cognitive states, attitudes and other aspects of personal touches and realism to a degree not previously possible.

At operation 450, at least one of a first graphical representation of the first speech, a second graphical representation of the second speech, and a third graphical representation of the combined synthetic speech may be displayed on a display device controlled by the processor using a quasi-musical staff indicating the respective prosodic elements. As an example, reference lines in the graphical representations 100-140 may be presented on a display in any combination.

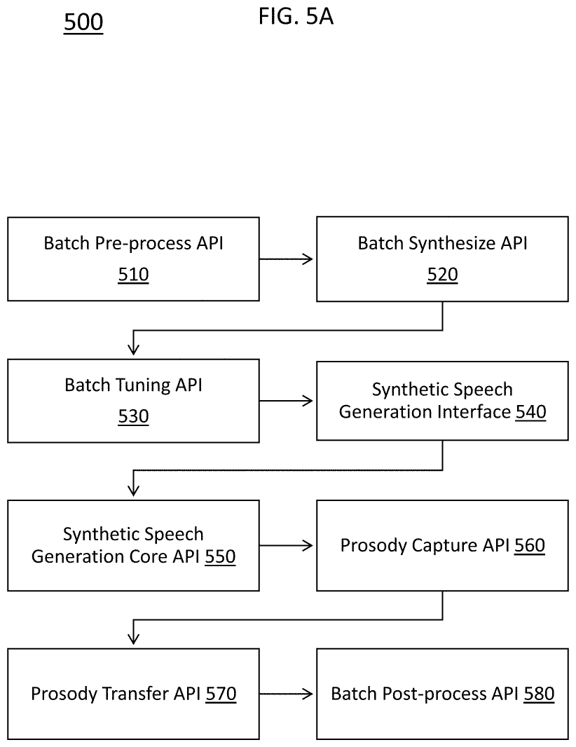

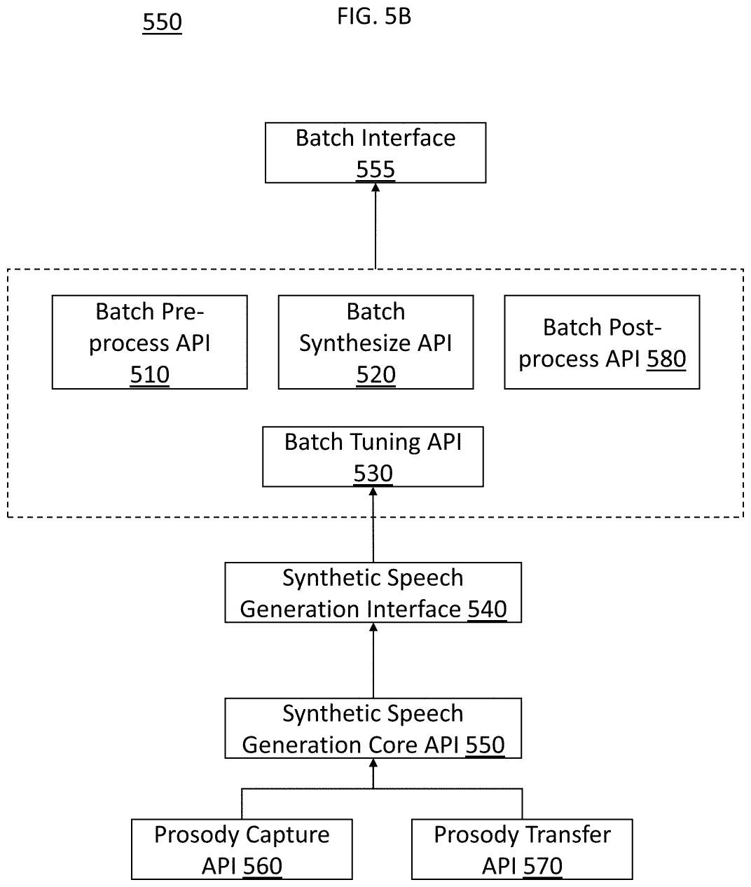

FIG. 5A-B are block diagrams illustrating exemplary API call flows in a batch or multi-segment system generating multiple synthetic speeches based on prosody capture and transfer.

FIG. 5A is an API call flow diagram 500 of an exemplary sequence of API call flows and interface actions for generating synthetic speech in a “batch” process using prosody capture and transfer.

As shown in the API call flow diagram 500, various application programming interfaces (API) elements may be used for generating synthetic speech in a “batch” process using prosody capture and transfer.

Batch pre-process API 510 may receive an original text file (or first speech) in original “bulk” format, e.g., as book or chapter, movie script, etc., and may insert markup indicating text formatting that can guide pronunciation (italics, bold, underlined, etc.). Batch pre-process API 510 may convert the original text file from the original format, e.g., Word file or PDF, into plain text or may extract text from the first speech. Batch pre-process API 510 may then break up that plain text into a list of separate text segments, suitable for individual synthesis and tuning. Each such separate segment may be a sentence, clause, or phrase, depending on the specified delimiters (punctuation marks, carriage returns, etc.).

Batch synthesize API 520 may perform a preliminary synthesis of the strings in list prepared by batch pre-process API 510, yielding a list of pairs, where each pair may consist of TTSFile, one untuned text-to-speech file corresponding to a string, and TTSText, the associated marked-up source text. Batch synthesize API 520 may deposit the resulting text-to-speech files from the list into a directory path.

Batch tuning API 530 may invoke a tuning tool to tune and/or correct the individual selected text-to-speech files produced by Batch synthesize API 520. Batch tuning API 530 may tune text-to-speech files consecutively, or may permit the user to select untuned files from a list offered in a separate window by Batch interface 555. Any suitable tuning tool may be used, e.g., tuning tools that offer native Play and Save features, so that results may be monitored during tuning and then saved.

In particular, however, the Synthetic speech generation interface 540 may enable tuning via prosody capture and prosody transfer by calling the Synthetic speech generation core API 550. Synthetic speech generation core API 550 may manage Prosody capture API 560 and Prosody transfer API 570 to capture prosody from a first voice clip and incorporate the captured prosody information, e.g., prosodic features, into an output synthetic speech. Synthetic speech generation core API 550 may also optionally handle (1) speech recognition to obtain missing text and (2) prosody capture for the current sub-segment.

Prosody capture 560 may extract prosodic information (e.g., pitch, duration, and energy) for each phoneme of the first speech audio file, with reference to the corresponding text.

Prosody transfer 570 may produce and deliver a synthetic speech segment in the specified voice, given a Text, a voice id, and a prosody information datastructure containing prosodic information (pitch, duration, and energy) for each sub-segment, e.g., phoneme, in the relevant sequence of phonemes.

Batch post-process API 560 may assemble a listed series of separate files (as produced by Batch tuning API 530) by concatenating them in order. During concatenation, separation between the separate segments obtained from the files may be specified via a global input parameter, e.g., at 0.75 seconds, and may be varied for added realism. Batch post-process API 560 may output a single audio file containing all the concatenated files; and may also output an updated text file which may reconstitute the original text file with any changes.

FIG. 5B is an API call flow diagram 550 illustrating an invocation view of the elements of the API call flow diagram 500 indicating exemplary input and output of the elements of the API call flow diagram 500.

Prosody capture API 560 may, for a given demo, or for a first audio file and the corresponding text, extract prosodic information (pitch, duration, and energy) for each of its sub-segments, e.g., its phonemes. Prosody capture API 560 may receive as input the demo (audio file) demonstrating the desired prosody for the current voice clip and demo text (string) containing the text corresponding to the demo audio file. Prosody capture 560 may generate as output prosody information as a data structure containing pitch, duration, and energy for each segment or sub-segment, e.g., each phoneme, in the demo audio file.

Prosody Transfer API 570 may produce and deliver—for a given demo text, a voice ID, and prosody information data structure containing prosodic information (pitch, duration, and energy) for a sequence of sub-segments—synthetic speech in the specified voice that incorporates the prosody information of the desired prosody. Prosody Transfer API 570 may receive as input a text string to be rendered, a voice ID, prosody information data structure, and instructions for generating synthetic speech in a specific output format, e.g., mp3, way. Prosody Transfer API 570 may generate as output the synthetic speech in the specified output format.

Synthetic speech generation core API 550 may capture prosody from the demo and incorporate the captured prosody information into the synthetic speech. It may also perform speech recognition to obtain missing text or unclear speech and may also enable prosody capture for a sub-part or segment of a whole speech segment. Synthetic speech generation core API 550 may receive as input the demo audio file, the voice ID, and the audio file with unsatisfactory prosody, the text to be rendered, and/or an output format. Synthetic speech generation core API 550 may generate as output the synthetic speech in a specified format.

Synthetic speech generation interface API 540 may enable prosody capture and prosody incorporation or transfer via the Synthetic speech generation core API 550. Synthetic speech generation interface API 540 may include controls needed for selecting, loading, and manipulating a speech or recording. The Synthetic speech generation interface API 540 may include methods of representing aspects of speech segments to be handled, e.g., using the innovative staff described herein, and may further enable input of a prosody demo from a microphone, as well as correction or tuning of prosody for a set of segments via the techniques described throughout this disclosure.

Batch pre-process API 510 receives an original text file or audio file in a “bulk” format. Batch pre-process API 510 may convert the original text or audio files into suitable formats for processing, possibly making use of markup indicating sections, speakers, etc. Batch pre-process API 510 may generate as output a segmented text file or audio file list.

Batch synthesize API 520 may convert the segmented text file or audio file list from batch pre-processing API 510 into a list of untuned text-to-speech files or speech files. Batch synthesize API 520 may receive as input segmented text files or audio files and a directory path specifying the file system location where output synthetic speech files should be deposited. Batch synthesize API 520 may generate as output a list of pairs composed of an untuned text-to-speech file or audio file and the associated text.

Batch tuning API 530 may invoke tuning tools to tune individual selected text-to-speech files or audio files generated by Batch synthesize 520. In an embodiment, Batch interface 555 offers a list of text-to-speech or audio segments. Batch tuning API 530 can then tune the individual segments in either a consecutive sequence or a free sequence. Given a directory path as input, Batch tuning API 530 may generate to it an updated list of tuned pairs (audio and text files) per the relevant operating system.

Batch post-process API 580 may assemble the files listed in the updated list of pairs generated by batch tuning API 520 by concatenating them in order. Separation between the files may be specified, e.g., at 0.75 seconds, or may be varying. Batch post-process API 580 may receive as input the updated list of pairs generated by batch tuning API 520 and the separation time. Batch post-process API 580 may generate as output a single audio file concatenating all files of the updated list of pairs, single text file, and any changes to the updated list of pairs generated by batch tuning API 520.

Batch interface API 555 may manage all the batch tuning processes including Batch tuning API 530, Batch pre-process API 510, Batch post-process API 580, and Batch synthesize API 520 with appropriate controls. Batch interface API 555 may enable input of the original text file or audio file; its separation into strings suitable for tuning; the synthesis of preliminary untuned text-to-speech files or audio files for all such strings; the tuning of each text-to-speech file or audio file to correct any mispronunciations or add any emphasis; and the assembly of all the text files and synthesized audio files (speech files) into a corresponding concatenated file.

The techniques described above can be implemented as computer software using computer-readable instructions and physically stored in one or more computer-readable media or by one or more specifically configured hardware processors.

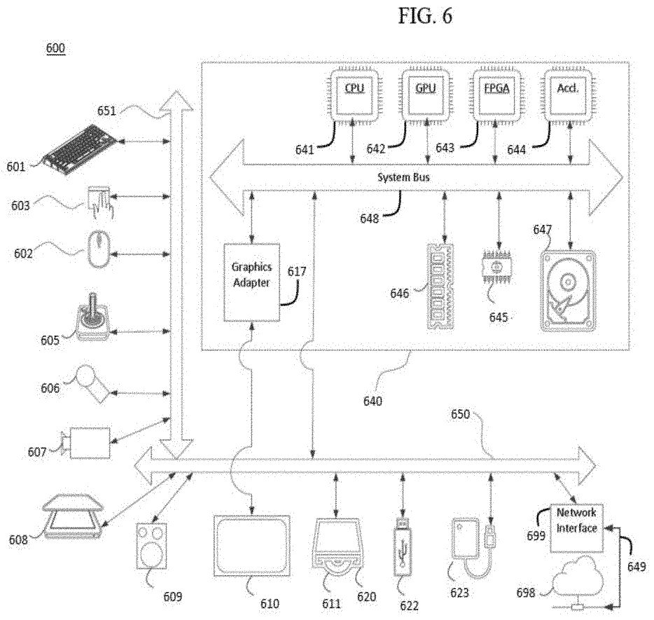

FIG. 6 shows an example of a computer system 600 for implementing various embodiments described above.

The computer software can be coded using any suitable machine code or computer language, which may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 6 for computer system 600 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 600.

Computer system 600 may include certain input devices. Such an input device may be responsive to input by one or more users through, for example, tactile input (such as: keystrokes, swipes, data glove movements), audio input (such as: voice, clapping), visual input (such as: gestures), olfactory input. The input devices can also be used to capture certain media such as audio (such as: speech, music, ambient sound), images (such as: scanned images, photographic images obtain from a still image camera), video (such as two-dimensional video, three-dimensional video including stereoscopic video).

Input devices may include one or more of (only one of each depicted in the example illustrated in FIG. 6): keyboard 601, mouse 602, trackpad 603, touch screen 610, joystick 605, microphone 606, scanner 608, camera 607.

Computer system 600 may also include certain output devices. Such output devices may be stimulating the senses of one or more users through, for example, tactile output, sound, light, and smell/taste. Such output devices may include tactile output devices (for example tactile feedback by the touch screen 610, or joystick 605, but there can also be tactile feedback devices that do not serve as input devices), audio output devices (such as: speakers 609, headphones), visual output devices (such as screens 610 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses, holographic displays and smoke tanks), and printers.

Computer system 600 can also include storage devices and their associated media such as optical media including CD/DVD ROM/RW 620 with CD/DVD 611 or the like media, thumb-drive 622, removable hard drive or solid-state drive 623, legacy magnetic media such as tape and floppy disc, specialized ROM/ASIC/PLD based devices such as security dongles, and the like.

Those skilled in the art should also understand that the term “computer readable media” as used in connection with the presently disclosed subject matter does not encompass transmission media, carrier waves, or other transitory signals.

Computer system 600 can also include interface 699 to one or more communication networks 698. Networks 698 can for example be wireless, wireline, optical. Networks 698 can further be local, wide-area, metropolitan, vehicular and industrial, real-time, delay-tolerant, and so on. Examples of networks 698 include local area networks such as Ethernet, wireless LANs, cellular networks to include GSM, 3G, 4G, 6G, LTE and the like, TV wireline or wireless wide area digital networks to include cable TV, satellite TV, and terrestrial broadcast TV, vehicular and industrial to include CANBus, and so forth. Certain networks 698 commonly require external network interface adapters that attached to certain general-purpose data ports or peripheral buses (750 and 651) (such as, for example USB ports of the computer system 600; others are commonly integrated into the core of the computer system 600 by attachment to a system bus as described below (for example Ethernet interface into a PC computer system or cellular network interface into a smartphone computer system). Using any of these networks 698, computer system 600 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

The aforementioned input output devices, storage devices, and network interfaces can be attached to a core 640 of the computer system 600.

The core 640 can include one or more Central Processing Units (CPU) 641, Graphics Processing Units (GPU) 642, a graphics adapter 617, specialized programmable processing units in the form of Field Programmable Gate Areas (FPGA) 643, hardware accelerators for certain tasks 644, and so forth. These devices, along with Read-only memory (ROM) 645, Random-access memory 646, internal mass storage such as internal non-user accessible hard drives, SSDs, and the like 647, may be connected through a system bus 648. In some computer systems, the system bus 648 can be accessible in the form of one or more physical plugs to enable extensions by additional CPUs, GPU, and the like. The peripheral devices can be attached either directly to the core's system bus 648, or through a peripheral bus 651. Architectures for a peripheral bus include PCI, USB, and the like.

CPUs 641, GPUs 642, FPGAs 643, and accelerators 644 can execute certain instructions that, in combination, can make up the aforementioned computer code. That computer code can be stored in ROM 645 or RAM 646. That computer code may implement operations 410-450 or implement APIs 510-580. Transitional data can be also be stored in RAM 646, whereas permanent data can be stored for example, in the internal mass storage 647. Fast storage and retrieval to any of the memory devices can be enabled through the use of cache memory, that can be closely associated with one or more CPU 641, GPU 642, mass storage 647, ROM 645, RAM 646, and the like.

The computer readable media can have computer code thereon for performing various computer-implemented operations. As an example, computer readable media may perform operations 410-450 or perform operations as instructed by APIs 510-580. The media and computer code can be those specially designed and constructed for the purposes of the present disclosure, or they can be of the kind well known and available to those having skill in the computer software arts.

As an example and not by way of limitation, the computer system 600 having the illustrated architecture, and specifically the core 640 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 640 that are of non-transitory nature, such as core-internal mass storage 647 or ROM 645. The software implementing various embodiments of the present disclosure can be stored in such devices and executed by core 640. A computer-readable medium can include one or more memory devices or chips, according to particular needs. The software can cause the core 640 and specifically the processors therein (including CPU, GPU, FPGA, and the like) to execute particular processes or particular parts of particular processes described herein, including defining data structures stored in RAM 646 and modifying such data structures according to the processes defined by the software. In addition or as an alternative, the computer system can provide functionality as a result of logic hardwired or otherwise embodied in a circuit (for example: accelerator 644), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

Various embodiments may be implemented as follows.

Implementation 1

According to a first implementation, a method for speech synthesis using prosody capture and transfer may include receiving a first speech in a target prosody; receiving a second speech in a target voice; extracting prosodic features from a first speech segment in the target prosody; and generating a synthetic speech segment in the target voice with the target prosody based on transferring the prosodic features from the first speech segment per phoneme to a second speech segment.

Implementation 2

According to a second implementation, the method of implementation 1 may include the first speech comprises a plurality of segments including the first speech segment.

Implementation 3

According to a third implementation, the method of implementations 1-2 may include the second speech may include more than one speech segment in a respective target voice including the second speech segment.

Implementation 4

According to a fourth implementation, the method of implementations 1-3 may include the first speech including a list of first segments in a respective target prosody including the first speech segment, wherein the second speech may include a corresponding list of second segments in a respective target voice including the second speech segment, and wherein synthetic speech correspondingly may include synthetic segments in the respective target voice in the respective target prosody, including the synthetic speech segment, based on transfer of respective prosodic features from respective first segments per phoneme to respective second segments.

Implementation 5

According to a fifth implementation, the method of implementations 1-4 may include the synthetic speech segment being a first synthetic speech, the first synthetic speech including improperly pronounced speech, and wherein generating a second synthetic speech with properly pronounced speech comprises selecting one or more phonemes from the first synthetic speech associated with the improperly pronounced speech; receiving one or more corresponding phonemes comprising the properly pronounced speech; and generating the second synthetic speech based on replacing the selected one or more phonemes in the first synthetic speech with the one or more corresponding phonemes.

Implementation 6

According to a sixth implementation, the methods of implementations 1-5 may include receiving a proper pronunciation of the improperly pronounced speech; and determining one or more phonemes of the properly pronounced speech based on the proper pronunciation.

Implementation 7

According to a seventh implementation, the methods of implementations 1-6 may include displaying on a display device controlled by the processor, at least one of a first graphical representation of the first speech, a second graphical representation the second speech, and a third graphical representation the synthetic speech using a quasi-musical staff for respective prosodic pronunciation.

Implementation 8

According to an eight implementation, the methods of implementations 1-7 may include the quasi-musical staff representing changes in a pitch of a speech segment as vertical changes, pitch intervals being represented in units of musical half-tones, and vertical changes in pitch are relative to a neutral pitch specific to individual voices or excitement levels.

Implementation 9

According to a ninth implementation, a computer system for speech synthesis using prosody capture and transfer may include first receiving code configured to cause the at least one processor to receive a first speech in a target prosody; second receiving code configured to cause the at least one processor to receive a second speech in a target voice; extracting code configured to cause the at least one processor to extract prosodic features from a first speech segment in the target prosody; and first generating code configured to cause the at least one processor to generate a synthetic speech segment in the target voice with the target prosody based on transferring the prosodic features from the first speech segment per phoneme to a second speech segment.

Implementation 10

According to a tenth implementation, the computer system of implementation 9 may include the first speech including a list of first segments in a respective target prosody including the first speech segment, wherein the second speech may include a corresponding list of second segments in a respective target voice including the second speech segment, and wherein synthetic speech correspondingly may include synthetic segments in the respective target voice in the respective target prosody, including the synthetic speech segment, based on transfer of respective prosodic features from respective first segments per phoneme to respective second segments.

Implementation 11

According to a eleventh implementation, the computer system of implementations 9-10 may include the synthetic speech being a first synthetic speech, the first synthetic speech including improperly pronounced speech, and wherein the first generating code may further include selecting code configured to cause the at least one processor to select one or more phonemes from the first synthetic speech associated with the improperly pronounced speech; third receiving code configured to cause the at least one processor to receive one or more corresponding phonemes comprising the properly pronounced speech; and second generating code configured to cause the at least one processor to generate the second synthetic speech based on replacing the selected one or more phonemes in the first synthetic speech with the one or more corresponding phonemes.

Implementation 12

According to a twelfth implementation, the computer system of implementations 9-11 may include the third receiving code further including fourth receiving code configured to cause the at least one processor to receive a proper pronunciation of the improperly pronounced speech; and determining code configured to cause the at least one processor to determine one or more phonemes of the properly pronounced speech based on the proper pronunciation.

Implementation 13

According to a thirteenth implementation, the computer system of implementations 9-12 may further include displaying code configured to cause the at least one processor to display on a display device controlled by the processor, at least one of a first graphical representation of the first speech, a second graphical representation the second speech, and a third graphical representation the synthetic speech using a quasi-musical staff for respective prosodic pronunciation.

Implementation 14

According to a fourteenth implementation, the computer system of implementations 9-13 may include the quasi-musical staff representing changes in a pitch of a speech segment as vertical changes, pitch intervals being represented in units of musical half-tones, and vertical changes in pitch are relative to a neutral pitch specific to individual voices or excitement levels.

Implementation 15

According to a fifteenth implementation, non-transitory computer-readable medium storing instructions, the instructions comprising: one or more instructions that, when executed by one or more processors of a device for speech synthesis using prosody capture and transfer may include instructions to receive a first speech in a target prosody; receive a second speech in a target voice; extract prosodic features from the first speech in the target prosody; and generate synthetic speech in the target voice with the target prosody based on transferring the prosodic features from the first speech per phoneme to the second speech.

Implementation 16

According to a sixteenth implementation, the non-transitory computer-readable medium of implementation 15 may include the first speech including a list of first segments in a respective target prosody including the first speech segment, wherein the second speech may include a corresponding list of second segments in a respective target voice including the second speech segment, and wherein synthetic speech correspondingly may include synthetic segments in the respective target voice in the respective target prosody, including the synthetic speech segment, based on transfer of respective prosodic features from respective first segments per phoneme to respective second segments.

Implementation 17

According to a seventeenth implementation, the non-transitory computer-readable medium of implementations 15-16 may include the synthetic speech being a first synthetic speech, the first synthetic speech including improperly pronounced speech, and wherein generating a second synthetic speech with properly pronounced speech comprises selecting one or more phonemes from the first synthetic speech associated with the improperly pronounced speech; receiving one or more corresponding phonemes comprising the properly pronounced speech; and generating the second synthetic speech based on replacing the selected one or more phonemes in the first synthetic speech with the one or more corresponding phonemes.

Implementation 18

According to an eighteenth implementation, the non-transitory computer-readable medium of implementations 15-17 may include receiving a proper pronunciation of the improperly pronounced speech; and determining one or more phonemes of the properly pronounced speech based on the proper pronunciation.

Implementation 19

According to a nineteenth implementation, the non-transitory computer-readable medium of implementations 15-18 may include displaying on a display device controlled by the processor, at least one of a first graphical representation of the first speech, a second graphical representation the second speech, and a third graphical representation the synthetic speech using a quasi-musical staff for respective prosodic pronunciation.

Implementation 20

According to a twentieth implementation, the non-transitory computer-readable medium of implementations 15-19 may include the quasi-musical staff representing changes in a pitch of a speech segment as vertical changes, pitch intervals being represented in units of musical half-tones, and vertical changes in pitch are relative to a neutral pitch specific to individual voices or excitement levels.

Techniques consistent with the present disclosure provide, among other features, systems and methods for synthesizing cross-lingual speech. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for speech synthesis using prosody capture and transfer, the method being implemented by a processor, the method comprising:
receiving a first speech in a target prosody;
receiving a second speech in a target voice;
extracting prosodic features from a first speech segment in the target prosody; and
generating a synthetic speech segment in the target voice with the target prosody based on transferring the prosodic features from the first speech segment per phoneme to a second speech segment.

2. The method of claim 1, wherein the first speech comprises a plurality of segments including the first speech segment.

3. The method of claim 1, wherein the second speech comprises more than one speech segment in a respective target voice including the second speech segment.

4. The method of claim 1, wherein the first speech comprises a list of first segments in a respective target prosody including the first speech segment, wherein the second speech comprises a corresponding list of second segments in a respective target voice including the second speech segment, and wherein synthetic speech correspondingly comprises synthetic segments in the respective target voice in the respective target prosody, including the synthetic speech segment, based on transfer of respective prosodic features from respective first segments per phoneme to respective second segments.

5. The method of claim 1, wherein the synthetic speech segment forms a first synthetic speech, wherein the first synthetic speech comprises improperly pronounced speech, and wherein generating a second synthetic speech with properly pronounced speech comprises:
selecting one or more phonemes from the first synthetic speech associated with the improperly pronounced speech;
receiving one or more corresponding phonemes comprising the properly pronounced speech; and
generating the second synthetic speech based on replacing the selected one or more phonemes in the first synthetic speech with the one or more corresponding phonemes.

6. The method of claim 5, wherein receiving the one or more corresponding phonemes comprising the properly pronounced speech comprises:
receiving a proper pronunciation of the improperly pronounced speech; and
determining one or more phonemes of the properly pronounced speech based on the proper pronunciation.

7. The method of claim 1, further comprising:
displaying, on a display device controlled by the processor, at least one of a first graphical representation of the first speech, a second graphical representation the second speech, and a third graphical representation the synthetic speech using a quasi-musical staff for respective prosodic elements.

8. The method of claim 7, wherein the quasi-musical staff represents changes in a pitch of a speech segment as vertical changes, wherein pitch intervals are represented in units of musical half-tones, and where vertical changes in pitch are relative to a neutral pitch specific to individual voices or excitement levels.

9. A computer system for speech synthesis using prosody capture and transfer, the computer system comprising:
at least one memory configured to store computer program code;
at least one processor configured to access the computer program code and operate as instructed by the computer program code, the computer program code including:
first receiving code configured to cause the at least one processor to receive a first speech in a target prosody;
second receiving code configured to cause the at least one processor to receive a second speech in a target voice;
extracting code configured to cause the at least one processor to extract prosodic features from a first speech segment in the target prosody; and
first generating code configured to cause the at least one processor to generate a synthetic speech segment in the target voice with the target prosody based on transferring the prosodic features from the first speech segment per phoneme to a second speech segment.

10. The computer system of claim 9, wherein the first speech comprises a list of first segments in a respective target prosody including the first speech segment, wherein the second speech comprises a corresponding list of second segments in a respective target voice including the second speech segment, and wherein synthetic speech correspondingly comprises synthetic segments in the respective target voice in the respective target prosody, including the synthetic speech segment, based on transfer of respective prosodic features from respective first segments per phoneme to respective second segments.

11. The computer system of claim 9, wherein the synthetic speech segment forms a first synthetic speech, wherein the first synthetic speech comprises improperly pronounced speech, and wherein the first generating code comprises:
selecting code configured to cause the at least one processor to select one or more phonemes from the first synthetic speech associated with the improperly pronounced speech;
third receiving code configured to cause the at least one processor to receive one or more corresponding phonemes comprising the properly pronounced speech; and
second generating code configured to cause the at least one processor to generate the second synthetic speech based on replacing the selected one or more phonemes in the first synthetic speech with the one or more corresponding phonemes.

12. The computer system of claim 11, wherein the third receiving code comprises:
fourth receiving code configured to cause the at least one processor to receive a proper pronunciation of the improperly pronounced speech; and
determining code configured to cause the at least one processor to determine one or more phonemes of the properly pronounced speech based on the proper pronunciation.

13. The computer system of claim 9, further comprising displaying code configured to cause the at least one processor to display on a display device controlled by the at least one processor, at least one of a first graphical representation of the first speech, a second graphical representation the second speech, and a third graphical representation the synthetic speech using a quasi-musical staff for respective prosodic elements.

14. The computer system of claim 13, wherein the quasi-musical staff represents changes in a pitch of a speech segment as vertical changes, wherein pitch intervals are represented in units of musical half-tones, and where vertical changes in pitch are relative to a neutral pitch specific to individual voices or excitement levels.

15. A non-transitory computer-readable medium storing instructions, the instructions comprising: one or more instructions that, when executed by one or more processors of a device for speech synthesis using prosody capture and transfer, cause the one or more processors to:
receive a first speech in a target prosody;
receive a second speech in a target voice;
extract prosodic features from a first speech segment in the target prosody; and
generate a synthetic speech segment in the target voice with the target prosody based on transferring the prosodic features from the first speech segment per phoneme to a second speech segment.

16. The non-transitory computer-readable medium of claim 15, wherein the first speech comprises a list of first segments in a respective target prosody including the first speech segment, wherein the second speech comprises a corresponding list of second segments in a respective target voice including the second speech segment, and wherein synthetic speech correspondingly comprises synthetic segments in the respective target voice in the respective target prosody, including the synthetic speech segment, based on transfer of respective prosodic features from respective first segments per phoneme to respective second segments.

17. The non-transitory computer-readable medium of claim 15, wherein the synthetic speech segment forms a first synthetic speech, wherein the first synthetic speech comprises improperly pronounced speech, and wherein generating a second synthetic speech with properly pronounced speech comprises:
selecting one or more phonemes from the first synthetic speech associated with the improperly pronounced speech;
receiving one or more corresponding phonemes comprising the properly pronounced speech; and
generating the second synthetic speech based on replacing the selected one or more phonemes in the first synthetic speech with the one or more corresponding phonemes.

18. The non-transitory computer-readable medium of claim 17, wherein receiving the one or more corresponding phonemes comprising the properly pronounced speech comprises:
receiving a proper pronunciation of the improperly pronounced speech; and
determining one or more phonemes of the properly pronounced speech based on the proper pronunciation.

19. The non-transitory computer-readable medium of claim 15, wherein the instructions further cause the one or more processors to display on a display device controlled by the one or more processors, at least one of a first graphical representation of the first speech, a second graphical representation the second speech, and a third graphical representation the synthetic speech using a quasi-musical staff for respective prosodic elements.

20. The non-transitory computer-readable medium of claim 19, wherein the quasi-musical staff represents changes in a pitch of a speech segment as vertical changes, wherein pitch intervals are represented in units of musical half-tones, and where vertical changes in pitch are relative to a neutral pitch specific to individual voices or excitement levels.
